(19) United States
(12) Patent Application Publication
(10) Pub. No.: US 2002/0002504 A1
(43) Pub. Date: Jan. 3, 2002

(54) Mobile shopping assistant system and device

(76) Inventors: Andrew Engel, Huntington Beach, CA (US); Peter Engel, West Hollywood, CA (US); Howard Cohl, West Hollywood, CA (US)

Correspondence Address: Paul A. Fattibene, Fattibene & Fattibene, 2480 Post Road, Southport, CT, 06490, US

(21) Appl. No.: 09/848,631

(22) Filed: May 3, 2001

Related U.S. Application Data
(60) Provisional application No. 60/202,220, filed on May 5, 2000.

(51) Int. Cl. G06F 17/60

(52) U.S. Cl. 705/26

(57) ABSTRACT

A mobile shopping assistant coupled to a global positioning system and a global computer network facilitating a potential consumer's purchasing decision. A mobile shopping assistant comprising an optical scanner and a global positioning system scans a bar code of a product. The information from the bar code along with location information of the mobile shopping assistant is transmitted to a global computer network such as the internet. Based upon the information provided, a price and discount server transmits back to the mobile shopping assistant pricing and location information about similar products. The potential consumer may then use this information to make a purchasing decision and to obtain the best value. The potential consumer saves considerable time in making a purchasing decision. Additionally, the potential consumer may save money, obtain a better value, or obtain the product more quickly based on the information provided. The potential consumer's use may be tracked and used to better serve the potential consumer.

### RELATED APPLICATION

This application claims the benefits of U.S. Provisional Application No. 60/202,220 filed May 5, 2000.

### FIELD OF THE INVENTION

The present invention relates in general to providing consumers with product information, and more particularly to a hand held computer used to provide information to a potential consumer for the purpose of making a purchasing decision.

### BACKGROUND OF THE INVENTION

Often, when consumers are looking for a product for potential purchase, they must spend considerable time in searching for the product at different locations. Accordingly, the potential consumer is often frustrated and uncertain as to whether the potential purchase of a selected product is a good value. Generally, conventional resources such as printed advertisements, radio or TV advertisements and other research tools provided to consumers, give the consumer with the ability to comparison shop.

However, this process is both time consuming and fraught with opportunities for unsatisfactory outcomes. For example, an advertisement may be misleading or represent only a limited supply of the advertised item. Employees may not be fully knowledgeable about the product and may not provide accurate information. Additionally, advertised items having a low price may not be readily available. Certain purchasing incentives such as coupons for discounts may be available at different locations, which will affect the net purchasing price. Additionally, it is often difficult for the consumer to compare products when the consumer must physically go to different locations at different times. It is often difficult for the consumer to accurately recollect the different products in order to make an accurate comparison. Accordingly, there is a need for a device and a system to assist consumers in the often tedious and difficult task of comparing products in order to obtain the best value.

### SUMMARY OF THE INVENTION

The present invention comprises a device and method permitting consumers to quickly and accurately compare products and pricing of a particular product that has been located of interest to the consumer. A handheld computer or mobile shopping assistant has an optical scanner attached thereto for reading a bar code associated with a selected product. The product information from the bar code is transferred to a price and discount server that is coupled to a global computer network to provide product pricing and information. The mobile shopping assistant is coupled to a global positioning system to provide global positioning information to identify the location and distance to a similar or related product. Consumer selections and user history are stored and subsequently analyzed for marketing purposes.

Accordingly, it is an object of the present invention to help consumers make purchasing decisions.

It is a further object of the present invention to provide the consumer with accurate information of comparable products of a single location.

It is an advantage of the present invention that it saves the consumer time and money.

It is a further advantage of the present invention that it provides marketing information on consumer selections.

It is a feature of the present invention that a bar scanner is used to provide initial product information.

It is another feature of the present invention that a wireless connection to a global computer network and global positioning system is used to provide product information and location.

These and other objects, advantages, and features will become readily apparent in view of the following detailed description.

### BRIEF DESCRIPTION OF THE DRAWINGS

FIG. 1 schematically illustrates a mobile shopping assistant system according to the present invention.

FIG. 2 schematically illustrates the features of a price and discount server.

FIG. 3 is a block diagram illustrating the acts or method steps for practicing the present invention.

### DETAILED DESCRIPTION OF THE PREFERRED EMBODIMENTS

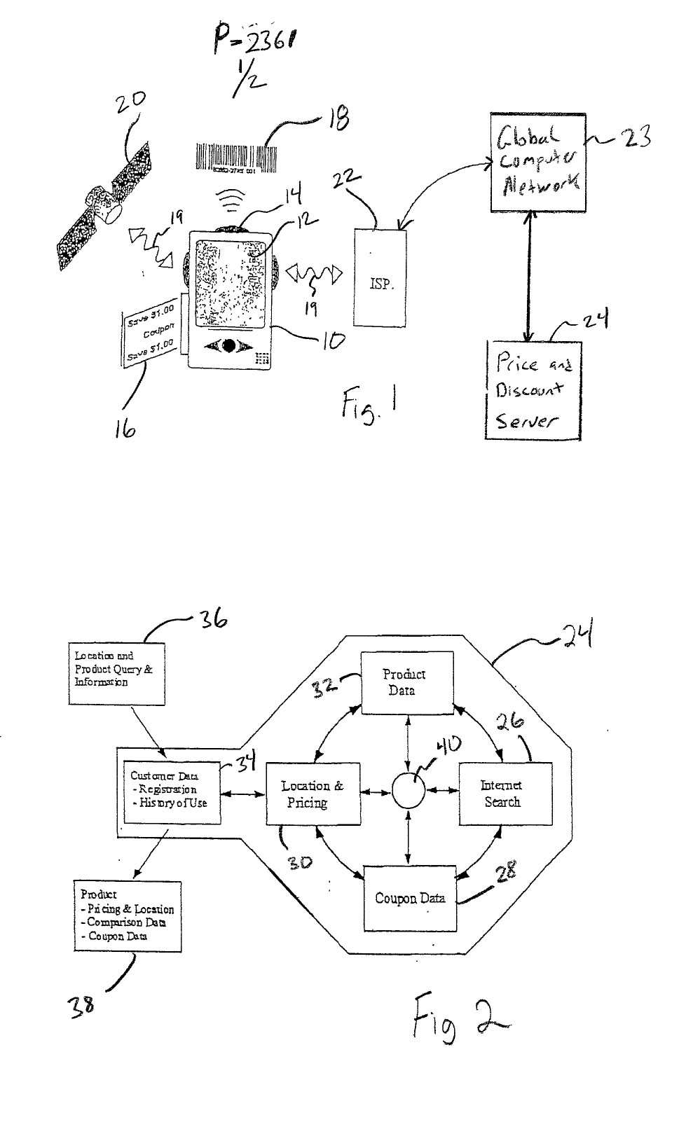

FIG. 1 schematically illustrates a mobile shopping assistant system. A mobile shopping assistant (MSA) device 10 has a display 12. Optical scanner 14 is associated with the mobile shopping assistant 10. A printer or other device associated with the mobile shopping assistant 10 may be utilized to print or transfer information related to a redemption certificate or coupon 16. The optical scanner 14 is used to read a bar code 18 that is associated with a product. The mobile shopping assistant device 10 is coupled to a global positioning system 20 (GPS) and an internet service provider 22 (ISP). Arrows 19 represent the coupling as a wireless connection. The mobile shopping assistant device 10 has integrated therewith transmitters and receivers sufficient to communicate with the global positioning system (20) and the internet service provider 22. The internet service provider 22 is utilized to connect to a global computer network 23 which in turn communicates with a price and discount server 24 (PDS).

Product information from the bar code 18 is provided to the mobile shopping assistant device 10, which may be a handheld type computer. The mobile shopping assistant device 10 obtains global position or location information from the global positioning system 20 to identify the location of the product associated with bar code 18. The mobile shopping assistant 10 coupled to the internet service provider 22 searches the global computer network and the price and discount server 24 to obtain information such as pricing, availability and location of similar products. The information is then displayed on display 12 of the mobile shopping assistant 10.

Accordingly, the current invention allows consumers to scan any product's bar code, and compare prices for exactly the same item in other nearby stores, as well as in virtual sites on the internet or other global computer network. Thus, consumers will be able to determine the best price for the product after they had completed their price comparison and decided upon the purchase. This is so whether the product is where they found it, at a nearby location, or on the internet. At the same time, consumers will be able to find any manufacturer's coupons or discounts applicable to the product even if the discounts are not being made available at the purchase location chosen.

Importantly, because the system checks bar codes, consumers will be sure that the apparently cheaper product available at another location is really the same, and not merely a less expensive “knock-off”. In addition, consumers may also ask for information about comparable but slightly different products and their prices and locations.

The mobile shopping assistant device 10, in association with the price and discount server 24, may also store consumer information or product selections. This allows service providers to gather a unique stream of marketing data. This is because the system determines the consumer's interest at the moment when a purchase decision is actually being made or rejected. Such an at purchase point data are obviously far more relevant for marketers than standard research which only ask consumers theoretically about what they would purchase. These data are more valuable than only tracking actual sales because it includes information about consumers who are interested enough in buying to check comparative prices and locations, but have not in fact complete a purchase. The mobile shopping assistant device 10 and associated optical scanner 14 scans and stores bar code information from products. Additionally, the mobile shopping assistant device 10 contains global positioning system (GPS) technology that allows the device's geographic position to be defined. Data is exchanged in a continuous or nearly continuous basis via wireless connection to a global computer network or web based price and discount server (PDS) through an internet service provider (ISP). The information uploaded by the Mobile Shopping Assistant device 10 (MSA) through its scanning function, is combined with geographic location information, generated by the GPS technology and is then transmitted to the PDS via a wireless connection. Based on this information, the PDS generates a list of sites, off line and geographically proximal, and on line where the scanned product may be purchased and at what price. Additionally, the PDS will transmit coupon data including nationally advertised, locally advertised, and in store coupons, which can be either printed out or transmitted electronically to the merchant for redemption. The entire purchasing process; that is scanning the product bar code, then obtaining price comparisons between the user's current location and a remote location or on line, then finding applicable coupons or discounts, and finally making the purchase, will be collected centrally to generate a unique sequence of marketing data reflecting the real time comparative process used by consumers to arrive at a purchasing decision

The Mobile Shopping Assistant device 10 may also have an integrally or detachable printer and has the capability to transmit data directly to a cash register via a wireless signal. Information related to a coupon 16 may be included in the information relating to the product. In the case of the availability of a coupon, the coupon availability as well as the location of the sites accepting the coupon may be indicated. When a coupon is available, the Mobile Shopping Assistant device 10 may print out or transmit the discount information to the merchant for redemption. This feature of the invention may have similar features as disclosed in U.S. patent application Ser. No. 09/650,908 filed Aug. 29, 2000 and entitled “Mobile Coupon Scanning and Locator System”, which is herein incorporated by reference.

Clearly, the Mobile Shopping Assistant device 10 may obtain information about the product utilizing the optical scanner 14, or the data may be manually entered from a keypad or key display, or verbally a voice activated system.

Additionally, the Mobile Shopping Assistant device 10 may be packaged as a stand alone data unit, or built together with other types of electronic devices such as telephones, digital music players, electronic book display units, electronic games, personal data assistants (PDA) or other handheld electronic or computing or communication devices.

In a typical example of use of the present invention by a consumer, the consumer may scan a bar code on a product of interest, such as a white Amana model 2050 refrigerator with an automatic icemaker. The consumer utilizing the Mobile Shopping Assistant device 10 may be located in a Sears store on Beach Boulevard and Eddinger Avenue in Huntington Beach, Calif. The bar code data, along with the GPS coordinates, are transmitted to the price and discount server via wireless connection to the internet. The price and discount server 24 may then return part or all of the following information. The actual advertised or sale price of the refrigerator at the present location. The price of the same make and model of refrigerator at another retail location that is within a user defined distance from the present location. A list of internet web sites that sell the same make and model of refrigerator and the price of purchase and time and cost of delivery. A coupon, discount, or rebate certificate for the produce scanned provided by the manufacturer and applicable to the product wherever it is purchased. At the consumer's request, information can also be provided about comparable brand and model of refrigerator available at the current or remote or virtual location.

FIG. 2 illustrates in more detail the price and discount server 24 as well as other features of the present invention. Box 26 represents an internet search function. Box 28 represents coupon data that is available for different products as well as the stores in which they may be redeemable. Box 30 represents product location and pricing data. Box 32 represents product data. Box 34 represents consumer data such as user registration information and the history of use by the consumer, including product information requested. Box 36 represents location and product query and information provided by the consumer in association with use of the Mobile Shopping Assistant device 10, illustrated in FIG. 1. Box 38 illustrates product information including pricing and location, comparison data and coupon data provided to the consumer through the Mobile Shopping Assistant device 10, illustrated in FIG. 1. Element 40 represents a data processor that links the various functions or features.

The price and discount server 24 provides a combination of relational data sets with interrelated functions. The PDS 24 is a repository for pricing information on goods and services that are located either at retail locations or virtual sites on the internet. These data are acquired in a variety of ways including, but not limited to, marketing relationships with manufacturers and retailers, automated and manual internet price searches, newspaper, magazine and store flyer searches and in-store units. The PDS 24 also acts as the storage site for the pricing and availability data. It also updates price, sale, discount, coupon and rebate information on a wide array of products and insures that the most current pricing is reflected in the stored data. The PDS 24 also acts as an on demand search engine to locate pricing and discounts for products that were not previously listed in the stored data set. This may be accomplished for example with the features of box 26.

The PDS 24 also functions to relate comparable products to one another based on an algoryhthm of matching features. It generates a similarity score based on features of the item so users viewing the information can quickly compare two given items similarities and differences. The PDS 24 also maintains and updates mobile shopping assistant user or consumer accounts. As part of the account associated with the MSA, users can select preferences for specific products, enter demographic information as well as other useful data. The account also contains the data generated with the use of the MSA. The stream of data relates to the products scanned and compared and the products scanned and compared and not purchased, as well as the products scanned, compared and purchased. Furthermore, it relates the location of the scanned products to the location of the purchased products. These features may be associated with box 34.

As a part of the maintaining of user accounts, the PDS may also function as a proxy server to transact remote E-commerce exchanges initiated by the user of the MSA. MSA users can create credit card accounts and passwords and shipping instructions as part of the registration process. It will allow them to purchase products from virtual locations while actively shopping.

The PDS 24 is primarily an internet based server that serves as a relational database. It searches for, manipulates and stores data on products, and is able to search the internet and other resources for products for which it has no data. When the Mobile Shopping Assistant device 10, illustrated in FIG. 1, user submits data to the price and discount server 24, the price and discount server 24 initially enters that request in a portion of the database that represents the consumer's registration data and use history, illustrated by box 34. It then compares the data submitted by the consumer or user to the stored product information, such as represented by box 32. The scope of the internal comparison is narrowed based on the association of the GPS location data with the product information request, such as represented by box 30. The price and discount server 24 also looks for coupons, discounts and rebates on the same product in that specific or nearby locations, such as represented by boxes 28 and 30. Should the price and discount server 24 find no stored information, it then utilizes the internet search function, represented by box 26, to scan the internet or other global computer network for information regarding the specific product. The internet search function is continuously active and searches for new information on product pricing and discounts. Once the requested information has been located, it is associated with the user profile and recorded as part of their history for later use in marketing similar products to the user. This data is then transmitted to the user where it may be displayed on the Mobile Shopping Assistant device 10, illustrated in FIG. 1. While the comparison of products has been illustrated, it should be appreciated that the use of the term products also includes services.

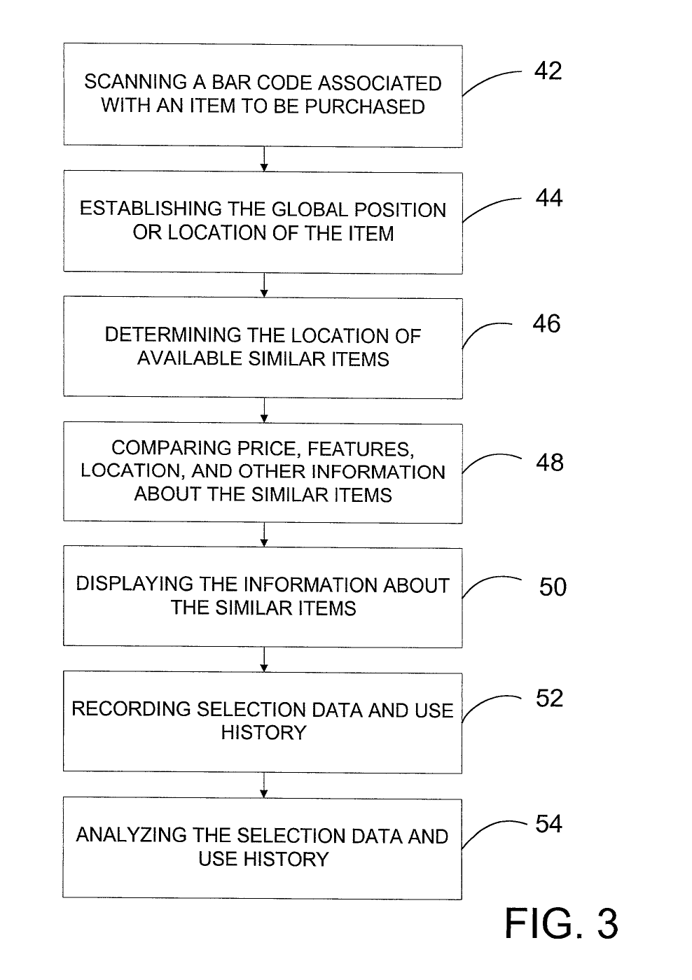

FIG. 3 is a block diagram illustrating the method steps or acts of the present invention. Box 42 represents the step of scanning a bar code associated with an item to be purchased. The item may be a product or service. Box 44 represents the step of establishing the global position or location of the item. Box 46 represents the method step of determining the location of available similar items. Box 48 represents the method step of comparing the price, features, location and other information about similar items. Box 50 represents the method step of displaying the information about the similar items to the potential consumer so that the consumer may make an informed purchasing decision. Box 50 represents the method step of recording selected data and use history of the items selected by the potential consumer. Box 54 represents the method step of analyzing the selected data and use history that has been previously recorded so as to better serve the needs of the potential consumer.

Accordingly, it should be appreciated that the present invention may take on a variety of different embodiments using known technologies to accomplish the same purposes as the described embodiments. The present invention provides an improved device and system to permit potential consumers to more quickly and easily identify and locate products or services of interest. The present invention makes possible the rapid comparison of similar products and services in order to find the best pricing or availability for the consumer facilitating the purchasing decision.

Additionally, the present invention provides valuable information related to consumer preferences and choices that may be utilized by marketing entities to better serve the potential consumer.

While several embodiments and configurations have been disclosed and described, it should be appreciated by those skilled in the art that various modifications may be made without departing from the spirit and scope of this invention.

What is claimed is:

1. A mobile shopping assistant device comprising:
a handheld computer;
a product information input device coupled to said handheld computer;
a display output device coupled to said handheld computer;
a global positioning system receiver coupled to said handheld computer, whereby the location of the handheld computer is capable of being determined; and
a wireless communication system coupled to said handheld computer capable of communicating with a global computer network,
whereby said product information input device provides product information and results in product pricing and location information to be provided to a potential consumer.

2. A mobile shopping assistant device as in claim 1 wherein:
said product information input device comprises an optical scanner, whereby said optical scanner is capable of reading a bar code placed on a product.

3. A mobile shopping assistant device as in claim 1 whereby:
said product information input device comprises voice activation.

4. A mobile shopping assistant device as in claim 1 further comprising:
a printer, whereby a coupon is capable of being printed.

5. A mobile shopping assistant comprising:
means for obtaining information about a selected product of interest;
means for identifying the physical location of the mobile shopping assistant;
means for searching a database to obtain the information about the selected product and location of similar products related to the selected product; and
means for displaying the information relating to the related products and the selected product to a potential consumer,
whereby the potential consumer is capable of making an informed purchasing decision.

6. A mobile shopping assistant device and system comprising:
a handheld computer;
a product information input device coupled to said handheld computer;
a display output device coupled to said handheld computer;
a global positioning system receiver coupled to said handheld computer, whereby the location of the handheld computer is capable of being determined; and
a wireless communication system coupled to said handheld computer capable of communicating with a global computer network; and
a price and discount server coupled to the global computer network and capable of storing price and location information about products,
whereby said optical scanner provides product information and said price and discount server provides product pricing and location information to be provided upon request to a potential consumer.

7. A mobile shopping assistant device and system as in claim 6 further comprising:
a customer data storage device coupled to said handheld computer.

8. A mobile shopping assistant device and system as in claim 6 further comprising:
processing means, associated with said price and discount server, for analyzing a potential consumer's use of the mobile shopping assistant device.

9. A mobile shopping assistant device and system as in claim 6 further comprising:
a printer coupled to said handheld computer.

10. A method of providing information to a potential consumer comprising the steps of:
scanning a bar code associated with a selected product of interest;
establishing a physical location of the selected product of interest;
determining another physical location of available products substantially the same as the selected product of interest;
comparing information about the available products relative to the selected product; and
displaying the selected information,
whereby the potential consumer is better informed to make a purchasing decision.

11. A method of providing information to a potential consumer as in claim 10 further comprising the steps of:
storing customer data relate to the potential consumer's selection of the selected product of interest; and
analyzing the customer date.

12. A method of providing information to a potential consumer about products comprising the steps of:
scanning a bar code associated with a selected product of interest with a handheld computer;
establishing a physical location of the selected product of interest with a global positioning system;
transmitting the physical location of the selected product of interest to a service provider connected to a global computer network;
coupling a price and discount server containing pre-selected information about the selected product of interest comprising price, location and discount information to the global computer network;
storing customer information and information identifying the selected product of interest;
searching the pre-selected information on the price and discount server for related information to the selected product of interest;
searching the global computer network for other information related to the selected product of interest comprising price, location, and discount information for the selected product of interest;
storing the other information related to the selected product of interest comprising price, location, and discount information for the selected product of interest on the price and discount server;
transmitting the related information and the other information related to the selected product to the handheld computer;
analyzing the customer information and the information identifying the selected product of interest;
determine proposed product information related to selected items that could be of interest to the customer;
transmitting the proposed product information to the handheld computer; and
displaying the related information, the other information, and the proposed product information for viewing by the potential consumer,
whereby the potential consumer is better informed to make a purchasing decision.
